(19) United States
(12) Patent Application Publication
(10) Pub. No.: US 2018/0370537 A1
(43) Pub. Date: Dec. 27, 2018

(54) SYSTEM PROVIDING REMAINING DRIVING INFORMATION OF VEHICLE BASED ON USER BEHAVIOR AND METHOD THEREOF

(71) Applicant: Chun-Yi Wu, Hsinchu (TW)

(72) Inventor: Chun-Yi Wu, Hsinchu (TW)

(21) Appl. No.: 15/859,024

(22) Filed: Dec. 29, 2017

(30) Foreign Application Priority Data
Jun. 22, 2017 (CN) 201710480871.1

(51) Int. Cl. B60W 40/09; G07C 5/08; B60R 16/023; B60K 35/00

(52) U.S. Cl. CPC B60W 40/09; G07C 5/0825; B60W 2050/146; B60K 35/00; B60K 2350/1092; B60R 16/0236

(57) ABSTRACT

A system providing remaining driving information of a vehicle based on user behavior includes a detection unit, a memory unit and a computation unit. The system stores information acquired by the detection unit during a moving progress of the vehicle to the memory unit to serve as history information, and accordingly generates a personalized model. The computation unit acquires current remaining energy information and at least one set of real-time information through the detection unit, inputs the same to the personalized model, and outputs a predictive remaining driving information to a display interface. The personalized model is generated based on user habits and behavior of various users, used vehicle and driving environment, and is thus capable of generating the personalized predictive remaining driving information. Accordingly, the personalized model integrating various personal factors, vehicle parameters and environment parameters can provide more accurate predictive information for reference of a user.

### FIELD OF THE INVENTION

The present invention relates to a system and method for a driving vehicle, and particularly to a system providing remaining driving information of a vehicle based on user behavior and a method thereof.

### BACKGROUND OF THE INVENTION

In a current vehicle, for example, a fuel gauge, an engine cooling system alert light and a vehicle charging system alert light, cannot be observed simply through the appearance of the vehicle, and are displayed on a dashboard for a driver to stay aware of conditions of the vehicle, so as to ensure driver safety.

With developments and progresses that come with time, requirements of a driver with respect to the precision and esthetic values of vehicle alert indicators are ever-increasing. The fuel gauge is one of the most important indicators that a driver constantly pays attention to, and there are numerous associated improvements in the prior art.

For example, the China Patent Application No. 103047991A discloses a prompting method for a driving route to a nearest gas station. In the above disclosure, a controller module is individually connected to an average fuel consumption calculation module, a remaining fuel detection module, a vehicle navigation module, a wireless data communication module and an audio playback module. The remaining mileage that a vehicle can further drive is determined by the controller module according to the average fuel consumption module and the remaining fuel detection module, a driving route to the nearest gas station is provided by the vehicle navigation module or the wireless data communication module, and the driving route is played on the audio playback module. Thus, a driver is prevented from neglecting and untimely paying attention to vehicle information, and thus from a dilemma of being stuck at a location where fuel has run out or overlooking driving safety caused by excessively focusing on the fuel gauge.

In another fuel management system, such as the Taiwan Patent No. 1313656, a built-in database is primarily disposed in a positioning device thereof. The database is pre-stored with a predetermined fuel volume value. A detection unit detects an actual fuel volume and compares the detected fuel volume with the predetermined fuel volume value. An alert is issued when the actual fuel volume is less than or equal to the predetermined fuel volume value.

The above fuel management system of the prior art merely compares the detected actual fuel volume with a predetermined fuel volume value. However, there are other factors that affect vehicle fuel consumption, and over-simplifying associated evaluation can result in lowered accuracy of a fuel management system. To satisfy driver needs, there is a need for a more accurate, intelligent and personalized fuel management system.

### SUMMARY OF THE INVENTION

It is a primary object of the present invention to solve over-simplified associated evaluation factors and resulted inadequate accuracy of a conventional fuel management system.

To achieve the above object, the present invention provides a system providing remaining driving information of a vehicle based on user behavior. The system includes: a detection unit, for acquiring time-varying information of a vehicle during a moving progress of the vehicle, wherein the information includes a vehicle parameter, a user habit parameter and an environment parameter, and is categorized into history information and real-time information according to time; a memory unit, electrically connected to the detection unit, for storing the history information acquired during the moving progress of the vehicle; and a computation unit, including a microprocessor, individually electrically connected to the detection unit and the memory unit, computing based on the history information of the memory unit to generate a personalized model. The computation unit acquires current remaining energy information and at least one set of real-time information from the detection unit, inputs the current remaining energy information and at least one set of real-time information to the personalized model, and outputs a predictive remaining driving information to a display interface for reference of a user.

In one embodiment of the present invention, the vehicle parameter includes at least one selected from a group consisting of an average speed from the vehicle, a vehicle mileage, a vehicle age, a vehicle load, a maintenance record of the vehicle, an aging condition of the vehicle, vehicle vibration data from the detection unit and specific fuel consumption.

In one embodiment of the present invention, the user habit parameter includes at least one selected from a group consisting of the number of times of braking, the number of times of gear switching, a steering wheel rotation amplitude, a user weight, time of using air conditioning, a force applied upon a pedal and eye movement of the user.

In one embodiment of the present invention, the environment parameter includes at least one selected from a group consisting of a weather temperature, ambient humidity, terrain information, and a position parameter.

In one embodiment of the present invention, the computation module establishes the personalized model through machine learning.

The present invention further provides a method for providing remaining driving information of a vehicle based on user behavior. The method includes steps S1 to S3.

In step S1, time-varying information of a vehicle during a moving progress of the vehicle at a time point tᵢ is acquired by a detection unit. The information includes a vehicle parameter, a user habit parameter and an environment parameter, and is categorized into history information and real-time information according to time.

In step S2, the history information acquired during the moving progress at the time point tᵢ of the vehicle is stored in a memory unit. The history information is transmitted to a computation unit individually electrically to the detection unit and the memory unit, and a microprocessor in the computation unit generates a personalized model through machine learning.

In step S3, when the vehicle moves at a time point tᵢ₊₁, the computation unit acquires current remaining energy information and at least one set of the real-time information through the detection unit, inputs the current remaining energy information and the at least one set of the real-time information to the personalized model, and outputs a predictive remaining driving information to a display interface for reference of a user.

In the method according to an embodiment of the present invention, the vehicle parameter includes at least one selected from a group consisting of the remaining energy information, an average speed from the vehicle, a vehicle mileage, a vehicle age, a vehicle load, a maintenance record of the vehicle, an aging condition of the vehicle, vehicle vibration data from the detection unit and specific fuel consumption.

In the method according to an embodiment of the present invention, the user habit parameter includes at least one selected from a group consisting of the number of times of braking, the number of times of gear switching, a steering wheel rotation amplitude, a user weight, time of using air conditioning, a force applied upon a pedal and eye movement of the user.

In the method according to an embodiment of the present invention, the environment parameter includes at least one selected from a group consisting of a weather temperature, ambient humidity, terrain information, and a position parameter.

In the method according to an embodiment of the present invention, the history parameter further includes the information acquired during the moving progress of the vehicle at the time point tᵢ₋₁˜t₀, and the microprocessor is caused to perform integrated computation on the information acquired at the time point tᵢ and the time point tᵢ₋₁˜t₀ to generate the personalized model.

Compared to the prior art, the present invention achieves following effects. In the present invention, the detection unit acquires time-varying information during the moving progress of the vehicle, the history information is stored in the memory unit, and computation is performed by the computation unit to generate a personalized model. Because data included in the history information differs due to operations or manipulations of different users, the model generated corresponds to a specific user and reflects utilization habits and behavior of the user, thereby more accurately predicting the predictive remaining driving information, such as driving time. Further, the remaining driving time predicted by the system of the present invention is time, which is different from mileage as in the prior art. For a user, the remaining driving time allows the user to more promptly and intuitively learn till when and where the vehicle can further drive based on the current resource conditions, as well as the time at which energy is to be supplemented next time.

### BRIEF DESCRIPTION OF THE DRAWINGS

FIG. 1 is a block diagram of a system providing remaining driving information of a vehicle based on user behavior based on an example of the present invention.

FIG. 2 is a block diagram of a system providing remaining driving information of a vehicle based on user behavior based on another example of the present invention.

FIG. 3 is a block diagram of a system providing remaining driving information of a vehicle based on user behavior based on another example of the present invention.

### DETAILED DESCRIPTION OF THE PREFERRED EMBODIMENTS

Details and technical contents of the present invention are given below.

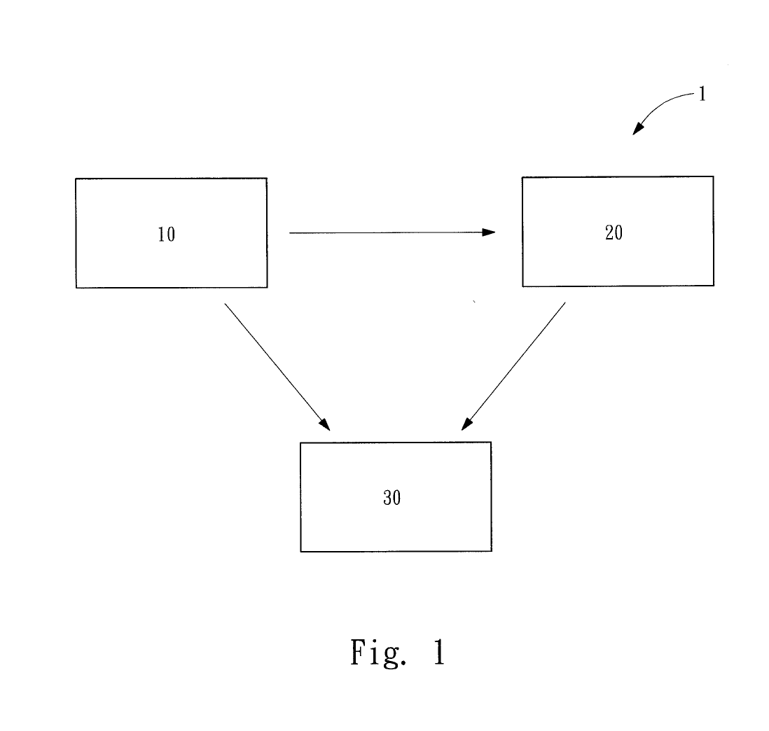

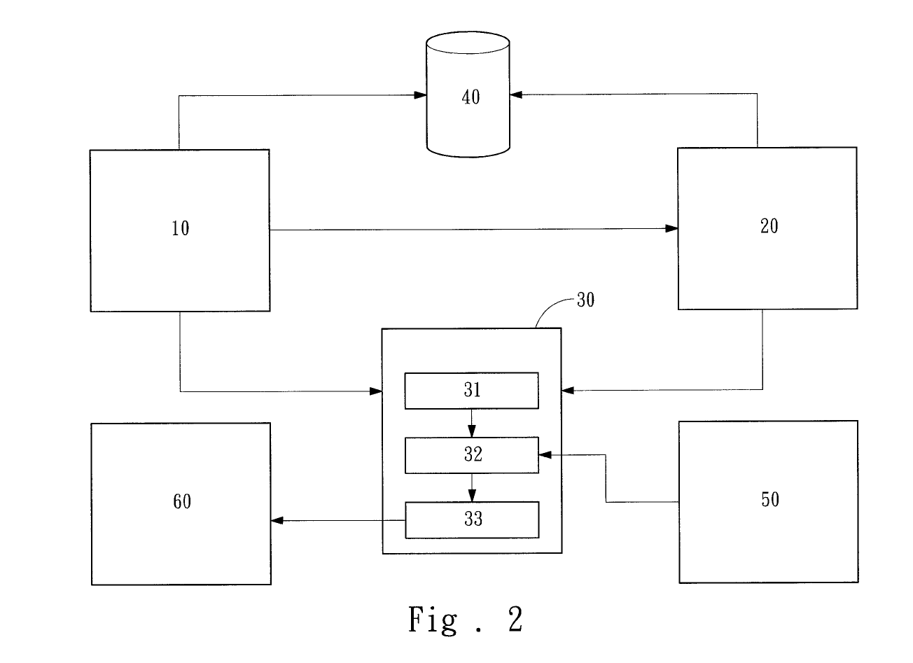

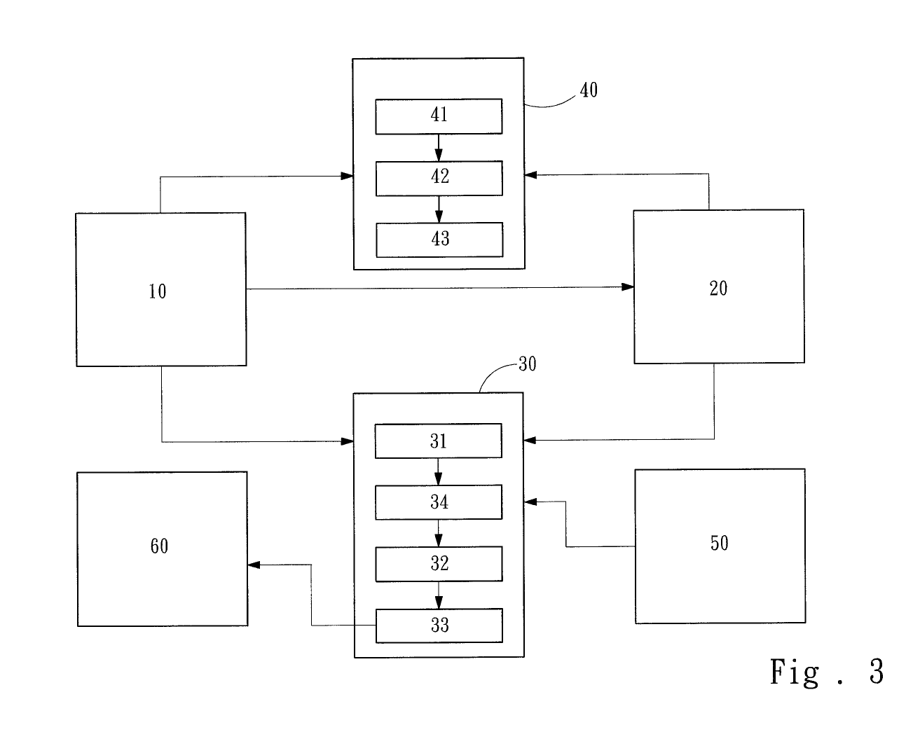

Referring to FIG. 1, FIG. 2 and FIG. 3, a system 1 providing remaining driving information of a vehicle includes a detection unit 10, a memory unit 20 and a computation unit 30. The detection unit 10 acquires time-varying information of a vehicle during a moving progress of the vehicle. The information is categorized into history information 40 and real-time information according to time, and includes a vehicle parameter 41, a user habit parameter 42 and an environment parameter 43 according to attributes. The vehicle parameter 41 is at least one factor associated with a vehicle condition. For example, the factor includes an average speed from the vehicle, a vehicle mileage, a vehicle age, a vehicle load, a maintenance record of the vehicle, an aging condition of the vehicle, vehicle vibration data from the detection unit 10 and specific fuel consumption, such as average fuel consumption per kilometer or mile. The user habit parameter 42 is at least one factor associated with a vehicle user habit, and includes, for example, the number of times of braking, the number of times of gear switching, a steering wheel rotation amplitude, a user weight, time of using air conditioning, a force applied upon a pedal, eye movement of the user, and other conditions associated with user driving habits. The environment parameter 43 is at least one factor associated with an environment in which the vehicle is driving, and includes, for example, a weather temperature, ambient humidity, terrain information and a position parameter. For example, the terrain information is road conditions, up/down hills and slopes of the hills, and the position information is longitudinal/latitudinal coordinates and country. In the present invention, the detection unit 10 may be implemented by various suitable detectors.

The memory unit 20 is electrically connected to the detection unit 10, and stores the history information 40 acquired during the moving progress of the vehicle. That is, in the present invention, after the information is acquired by the detection unit 10, the information is stored as the history information 40 to the memory unit 20 electrically connected to the detection unit 10. Further, the information acquired during the most recent two times, five times, ten times, fifteen times, thirty times or more of moving progresses of the vehicle can be stored as the history information 40 according to requirements. In addition, in one embodiment of the present invention, the memory unit 20 can also store utilization parameters of a plurality of users of the vehicle, and a specific user may be selected when the vehicle is initially started or during the driving progress of the vehicle. Thus, the system 1 providing remaining driving information of a vehicle based on user behavior of the present invention can better satisfy goals of providing better accuracy and personalization.

In the present invention, the memory unit 20 may be configured as a local database mounted in the vehicle, a cloud database mounted outside the vehicle, or a combination of the two. For example, the local database can be installed in the vehicle, and the detection unit 10 first stores the information of the current driving in the local database, and transmits the information to the cloud database for storage after the current driving has ended. As such, the local database can be cleared for further use of the next driving.

The computation unit 30 includes a microprocessor 31, is individually electrically connected to the detection unit 10 and the memory unit 20, and computes the history information 40 of the memory unit 20 to generate a personalized model 32.

Accordingly, after the computation unit 30 acquires the current remaining energy information 50 and the real-time information from the detection unit 10, the computation unit 30 inputs the current remaining energy information 50 and the real-time information to the personalized model 32, and outputs a predictive remaining driving information 33 to a display interface 60 for reference of a user. The “real-time” information is, at a moment during the moving progress, the information acquired by the detection unit 10. In the present invention, the “energy” is various types of energy sources for driving the vehicle, such as fuel, a battery (a fuel cell or a solar cell), and a compressed gas. For example, the fuel may be gasoline, diesel, bio-fuel, methanol, ethanol and ammonia; the battery may be a lithium battery, a NiMH battery, a fuel cell and a solar cell.

For example, during an operation, the computation unit 30, through machine learning 34, uses the history information 40 of the vehicle user driving the vehicle in the past as an input characteristic, and uses a remaining driving time per unit remaining resource as an output target to accordingly acquire the personalized model 32. For example, the machine learning 34 may be a neural network, a support vector machine, stochastic decision making, deep learning and logistic regression. Thus, after the personalized model 32 is established, the computation unit 30 inputs the current remaining energy information 50 and at least one set of real-time information to the personalized model 32, and accordingly obtains the predictive remaining driving information 33 through integrated evaluation based on the vehicle parameter 41, the user habit parameter 42 and/or the environment parameter 43. Further, in the present invention, the personalized model 32 changes according to the number of sets of the history information 40 collected.

In the present invention, the system 1 providing remaining driving information of a vehicle based on user behavior is applicable to various types of vehicles. For example, the system 1 may be installed, without any limitation, in a sedan, a truck, or a large passenger vehicle such as a bus or a tour coach bus, and the vehicle may be also be an auto-drive vehicle of level 0 to level 5 as defined by the United States National Highway Traffic Safety Administration (NHTSA).

A method for operating the system 1 providing remaining driving information of a vehicle based on user behavior of the present invention includes steps S1 to S3 below.

In step S1, time-varying information of a vehicle during a moving progress of the vehicle at a time point tᵢ is acquired by a detection unit 10. The information includes a vehicle parameter 41, a user habit parameter 42 and an environment parameter 43, and is categorized into history information 40 and real-time information according to time.

In step S2, the history information 40 acquired during the moving progress of the vehicle at the time point tᵢ is stored to a memory unit 20, the history information 40 is transmitted to a computation unit 30 individually electrically connected to the detection unit 10 and the memory unit 20, and a microprocessor 31 in the computation unit 30 generates a personalized model 32 through machine learning 34.

In step S3, when the vehicle moves at a time point tᵢ₊₁, the computation unit 30 acquires current remaining energy information 50 and at least one set of the real-time information through the detection unit 10, inputs the current remaining energy information 50 and the at least one set of the real-time information to the personalized model 32, and outputs a predictive remaining driving information 33 to a display interface 60 for reference of a user.

For example, the time-varying information of the moving progress of the vehicle at the time point tᵢ includes the vehicle parameter 41, the user habit parameter 42 and the environment parameter 43, which are all detected by the detection unit 10 and transmitted to the memory unit 20 electrically connected to the detection unit 10 to serve as the history information 40. Integrated computation is performed on the history information 40 by a microprocessor 31 in the computation unit 30 to generate a personalized model 32. Thus, for a next movement of the vehicle, i.e., when the vehicle moves at a time point tᵢ₊₁, the computation unit 30 acquires, through the detection unit 10 during a current moving progress, the current remaining energy information 50 and at least one set of real-time information (i.e., a weather temperature and/or a vehicle loading), inputs the current remaining energy information 50 and the at least one set of the real-time information to the personalized model 32, and outputs the predictive remaining driving information 33 to the display interface 60 for reference of a user.

It should be noted that, in one embodiment of the present invention, in addition to the time-varying information of the moving progress at the one single time point tᵢ of the vehicle, the history information 40 may further include the information of a previous movement of the vehicle before the time point tᵢ, i.e., information at a time point tᵢ₋₁, and the microprocessor 31 is caused to perform integrated computation on the information acquired during moving progresses at the time point tᵢ and the time point tᵢ₋₁˜t₀, wherein the information at time point t₀ may be defined as an initial data of the model. Thus, in the next movement of the time point tᵢ, i.e., at a time point tᵢ₊₁, when the computation unit 30 acquires the current remaining energy information 50 through the detection unit 10 and inputs the information acquired at the time point tᵢ and tᵢ₋₁ to perform integrated computation to generate the personalized model 32, the system 1 providing remaining driving information of a vehicle based on user behavior of the present invention can generate the personalized model 32 based on a larger amount of history information 40, hence more accurately outputting the predictive remaining driving information 33 to the display interface 60 for reference of a user.

In other embodiments, a previous movement of the vehicle before a time point tᵢ₋₁ may be further included, i.e., information at the time point tᵢ₋₂. At this point, the history information 40 includes the information acquired at the time point tᵢ, the time point tᵢ₋₁ and the time point tᵢ₋₂. Alternatively, in another embodiment, a previous movement of the vehicle before the time point tᵢ₋₂, i.e., information at a time point tᵢ₋₃, may be further included. At this point, the history information 40 includes the information acquired at the time point tᵢ, the time point tᵢ₋₁, the time point tᵢ₋₂ and the time point tᵢ₋₃. The present invention does not limit the number of set of history information 40. The history information 40 may also include the information acquired in the most recent two times, five times, ten times, fifteen times, thirty times or more of moving progresses of the vehicle.

Details of the vehicle parameter 41, the user habit parameter 42 and the environment parameter 43 in the above method are as defined in the previous description, and are omitted herein.

In conclusion, in the present invention, the detection unit 10 acquires time-varying information of a vehicle during the moving progress of the vehicle, the acquired information is stored in the memory unit 20, and a personalized model 32 is generated accordingly. Because data included in the history information 40 differs due to operations or manipulations of different users, the model generated corresponds to a specific user and reflects utilization habits and behavior of the user, thereby more accurately predicting the predictive remaining driving information 33, such as driving time.

Further, the predictive remaining driving information 33 predicted by the system 1 of the present invention is time, which is different from mileage as in the prior art. For a user, the remaining driving time allows the user to more promptly and intuitively learn till when and where the vehicle can further drive based on the current resource conditions, as well as the time at which energy is to be supplemented next time.

What is claimed is:

1. A system providing remaining driving information of a vehicle based on user behavior, comprising:
a detection unit, for acquiring time-varying information of the vehicle during a moving progress of the vehicle, the information comprising a vehicle parameter, a user habit parameter and an environment parameter and categorized into history information and real-time information according to time;
a memory unit, electrically connected to the detection unit, for storing the history information acquired during the moving progress of the vehicle; and
a computation unit, comprising a microprocessor, individually electrically connected to the detection unit and the memory unit, for computing based on the history information of the memory unit to generate a personalized model;
wherein, the computation unit acquires a current remaining energy information and at least one set of the history information from the memory module, inputs the current remaining energy information and the at least one set of the history information to the personalized model, and outputs a predictive remaining driving information to a display interface for reference of a user.

2. The system according to claim 1, wherein the vehicle parameter is at least one consisting of an average speed from the vehicle, a vehicle mileage, a vehicle age, a vehicle load, a maintenance record of the vehicle, an aging condition of the vehicle, vehicle vibration data from the detection unit and specific fuel consumption.

3. The system according to claim 1, wherein the user habit parameter comprises at least one consisting of the number of times of braking, the number of times of gear switching, a steering gear rotation amplitude, a user weight, time of using air conditioning, a force applied upon a pedal and eye movement of the user.

4. The system according to claim 1, wherein the environment parameter is at least one consisting of a weather temperature, ambient humidity, terrain information and a position parameter.

5. The system according to claim 1, wherein the computation unit establishes the personalized model through machine learning.

6. A method for providing remaining driving information of a vehicle based on user behavior, comprising:
acquiring time-varying information of the vehicle during a moving progress of the vehicle at a time point tᵢ by a detection unit, the information comprising a vehicle parameter, a user habit parameter and an environment parameter and categorized into history information and real-time information according to time;
storing the history information acquired during the moving progress of the vehicle at the time point tᵢ to a memory unit, transmitting the history information to a computation unit individually electrically connected to the detection unit and the memory unit, performing integrated computation by a microprocessor in the computation unit through machine learning to generate a personalized model;
wherein, when the vehicle moves at a time point tᵢ₊₁, the computation unit acquires a current remaining energy information and at least one set of the history information through the detection unit, inputs the current remaining energy information and the at least one set of the history information to the personalized model, and outputs a predictive remaining driving information to a display interface for reference of a user.

7. The method according to claim 6, wherein the vehicle parameter is at least consisting of the remaining energy information, an average speed from the vehicle, a vehicle mileage, a vehicle age, a vehicle load, a maintenance record of the vehicle, an aging condition of the vehicle, vehicle vibration data from the detection unit and specific fuel consumption.

8. The method according to claim 6, wherein the user habit parameter comprises at least one consisting of the number of times of braking, the number of times of gear switching, a steering gear rotation amplitude, a user weight, time of using air conditioning, a force applied upon a pedal and eye movement of the user.

9. The method according to claim 6, wherein the environment parameter is at least one consisting of a weather temperature, ambient humidity, terrain information and a position parameter.

10. The method according to claim 6, wherein the history information further comprises the information of the vehicle acquired during a moving progress at a time point tᵢ₋₁˜t₀, and the microprocessor is caused to perform the integrated computation on the information acquired during the moving progresses at the time point tᵢ and the time point tᵢ₋₁˜t₀ to generate the personalized model.
